(19) United States
(12) Patent Application Publication
(10) Pub. No.: US 2010/0013651 A1
(43) Pub. Date: Jan. 21, 2010

(54) DEVICE WITH DISPLAY AND CONTROLLER FOR CONTROLLING DISPLAYED INFORMATION IN RESPONSE TO MOVEMENT

(75) Inventor: Karin Johanne Spalink, Durham, NC (US)

Correspondence Address: SNYDER, CLARK, LESCH & CHUNG, LLP, 754 ELDEN STREET, SUITE 202, HERNDON, VA, 20170, US

(73) Assignee: Sony Ericsson Mobile Communications AB

(21) Appl. No.: 12/173,348

(22) Filed: Jul. 15, 2008

(51) Int. Cl. G08B 21/00; H04M 1/00

(52) U.S. Cl. 340/669; 455/575.1

(57) ABSTRACT

A device including a housing having a curved support surface, and a display provided on the housing. The display is configured to display information. The device further includes a sensor configured to sense rolling movement of the housing, and a controller configured to influence the information displayed on the display in response to the rolling movement sensed by the sensor.

### TECHNICAL FIELD

The present disclosure relates to interactive devices having displays and, more particularly, to controlling the manner in which information is displayed on the devices.

### BACKGROUND

Numerous devices available on the market today include displays that facilitate user interaction with the device. For example, the displays provided on mobile telephones, personal digital assistants (PDAs), etc. allow users to view and interact with a wide variety of applications, such as contact lists, calendar planners, mapping software, etc. Typically interaction with applications on such devices occurs using a keypad or touchscreen technology. However, such interaction can be cumbersome and non-intuitive when numerous different buttons are required in order to perform simple manipulations of displayed information. Also, the use of touchscreen technology can leave the display smeared with finger prints.

Therefore, the need exists for an improved ability to control displayed information.

### Disclosure

The above described needs are fulfilled, at least in part, by providing a device having a controller configured to allow influencing of displayed information in response to movement of a housing of the device.

An embodiment of a device can, for example, advantageously include a housing having a curved support surface, a display provided on the housing, where the display is configured to display information, a sensor configured to sense rolling movement of the housing, and a controller configured to control the information displayed on the display in response to the rolling movement sensed by the sensor.

A further embodiment of a device can, for example, advantageously include a housing having a curved support surface, a display provided on the housing, where the display is configured to display information, and means for influencing the information displayed on the display in response to rolling movement of the housing.

A further embodiment of a method of influencing information displayed on a display of a device can, for example, advantageously include sensing rolling movement of a housing of the device having a curved support surface, and influencing the information displayed on the display in response to the sensed rolling movement of the housing.

Additional advantages of the present disclosure will become readily apparent to those skilled in this art from the following detailed description, wherein preferred embodiments of the disclosure is shown and described, simply by way of illustration of the best mode contemplated. As will be realized, the disclosure is capable of other and different embodiments, and its several details are capable of modifications in various obvious respects. Accordingly, the drawings and description are to be regarded as illustrative in nature, and not as restrictive.

### BRIEF DESCRIPTION OF THE DRAWINGS

FIG. 1A is a perspective view of an embodiment of a device that is configured to control displayed information thereon in response to movement thereof, FIG. 1B is a transverse, cross-sectional view of the device of FIG. 1A shown in a rest position/orientation, FIG. 1C is a transverse, cross-sectional view of the device of FIG. 1A shown in a second position/orientation, and FIG. 1D is a transverse, cross-sectional view of the device of FIG. 1A shown in a third position/orientation.

FIG. 2A is a partial top plan view of the device of FIG. 1A showing a display thereof when the device is in the rest position/orientation of FIG. 1B, FIG. 2B is a partial top plan view of the device of FIG. 1A showing the display thereof when the device is in the second position/orientation of FIG. 1C, and FIG. 2C is a partial top plan view of the device of FIG. 1A showing the display thereof when the device is in the third position/orientation of FIG. 1D.

FIG. 3 is a block diagram of device components used for implementing the embodiment of the device illustrated in FIGS. 1A-1D and 2A-2C.

FIG. 4 is a perspective view of an additional embodiment of a device that is configured to control displayed information thereon in response to movement thereof.

FIG. 5A is a front elevational view of a further embodiment of a device that is configured to control displayed information thereon in response to movement thereof, and FIG. 5B is a top plan view of the device of FIG. 5A.

FIG. 6A is a partial top plan view of the device of FIGS. 5A and 5B showing a display thereof when the device is in a rest position/orientation, FIG. 6B is a partial top plan view of the device of FIGS. 5A and 5B showing the display thereof when the device is in a second position/orientation, and FIG. 6C is a partial top plan view of the device of FIGS. 5A and 5B showing the display thereof when the device is in a third position/orientation.

### DETAILED DESCRIPTION

Embodiments of the present disclosure will be described hereinafter with reference to the accompanying drawings. In the following description, the constituent elements having substantially the same function and arrangement are denoted by the same reference numerals, and repetitive descriptions will be made only when necessary.

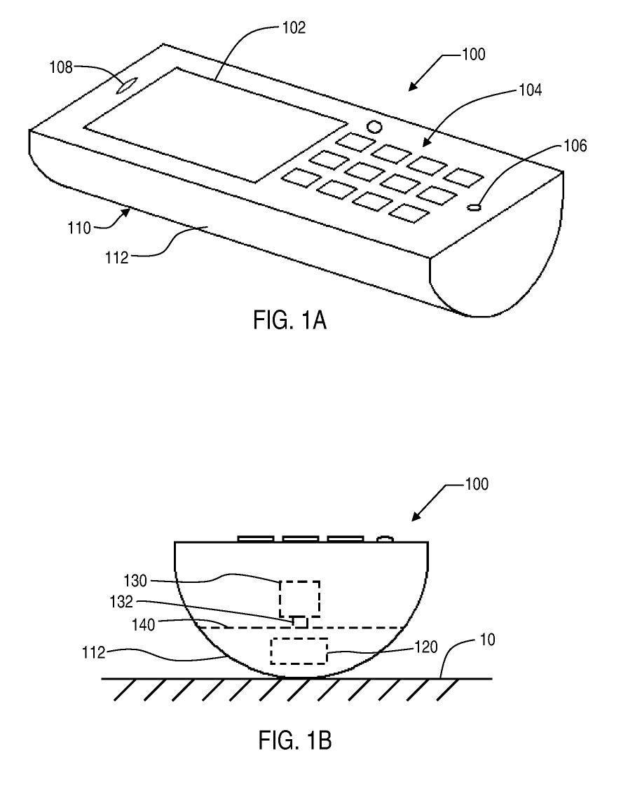

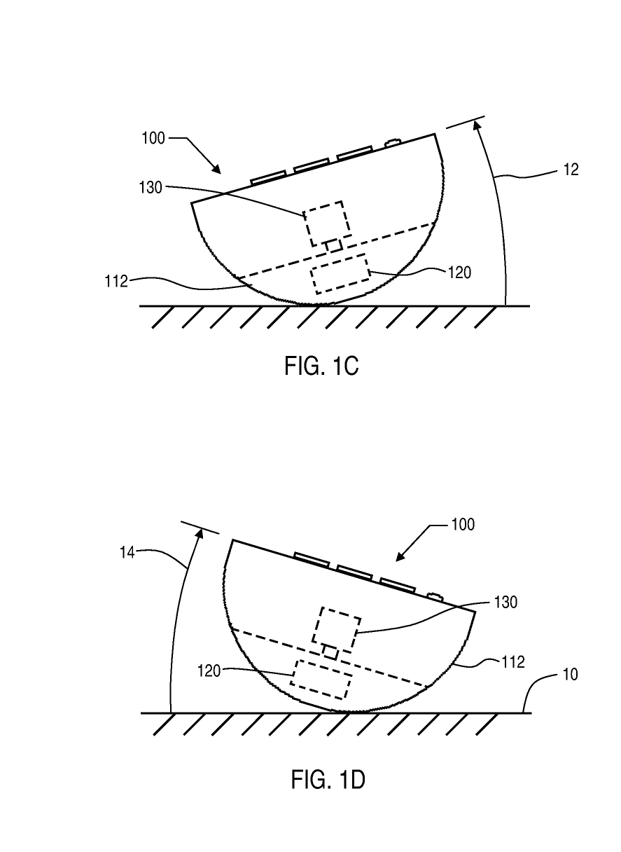

FIG. 1A depicts an embodiment of a device 100 having a display 102. While the embodiment depicted is configured as a wireless telephone, the device can be configured as any variety of devices (e.g., wireless or wired public switched telephone network device, a voice over internet protocol device, any variety of wireless communication devices such as a cellphone, personal digital assistant, pager, two-way radio transceiver, etc.).

The device 100 depicted in FIG. 1A includes the display 102, a keypad or keyboard 104, a microphone 106, and a speaker 108. The display 102 can be configured as a touchscreen device that can be used to input various commands, as well as displaying information. The keyboard 104 can include any number and variety of user input devices, such as buttons used to enter numbers, letters, or other input commands.

The device 100 includes a housing 110 that includes a curved support surface 112, which in this embodiment is a rear surface of the housing 110. In this embodiment, the curved support surface 112 is in the shape of a half cylinder; however, the support surface could be curved in any alternative configuration such as spherical, oval, or any symmetrical or non-symmetrical curved surface (e.g., when viewed along one or more of a transverse cross-section (see FIG. 1B) or a longitudinal cross-section, the curved support surface can be semi-circular, semi-elliptical, semi-oval, parabolic, etc.). The support surface 112 is a surface of the housing upon which the device 100 is typically rested when the device 100 is placed upon a supporting surface, such as planar supporting surface 10 shown in FIGS. 1B-1D. As mentioned above, the curved support surface 112 is in the shape of a half cylinder, and thus the housing 110 of the device 100 can roll or pivot about an imaginary axis when the housing 110 is supported by a supporting surface 10 and a force is applied to the housing 110.

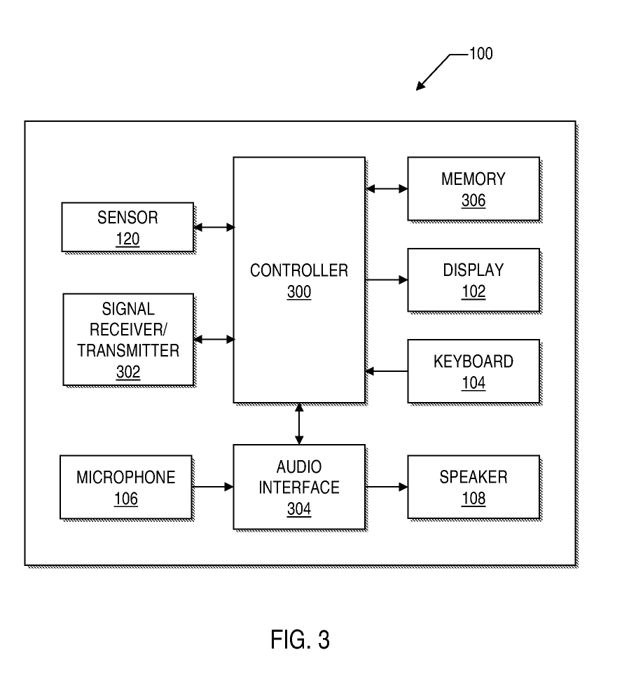

The device 100 includes a sensor 120 that is capable of acting as a motion/orientation detector. The sensor 120 is configured to sense the motion of the device 100, and is preferably configured to sense the orientation of the device at any given instant. For example, the sensor 120 can include one or more of an angular and/or linear accelerometer, a gyroscope, or any other device capable of performing such functions. The sensor 120 can also be configured to activate, in conjunction with a controller 300 in FIG. 3, the movement-controlled display feature of the device if the device is in a certain orientation (e.g., if the device is in the rest orientation/position shown in FIG. 1B), or deactivate this feature if the device is in a certain orientation (e.g., if the device is resting on a top face of the housing rather than the curved support surface or in some other orientation at which this feature is not desired to be used).

In the embodiment depicted in FIGS. 1B-1D, the device 100 includes a weight 130, which can be a battery of the device 100. The weight 130 is supported on a surface 140 using a support member 132. If desired, the weight 130 can be moveably provided within the housing in order to allow for the device 100 to change a rest orientation/position thereof by shifting the weight 130 within the housing 110. For example, the surface 140 can be provided as a track and the weight 130 can be slidably received by the track 140 along transverse directions of the device, and a motive device or motor (not shown) can be provided that moves the weight 130 along the track 140. Such a configuration can be used to change a center of gravity of the device 100.

The device 100 can be constructed in a manner such that the depiction in FIG. 1B is a typical rest position, where the housing 110 is rested upon the planar supporting surface 10 and the device 100 is generally balanced on a center of the curved support surface 112 with an upper face including the display 102 and keyboard 104, for example, being in a generally horizontal configuration. Of course, the device 100 can be constructed to have some other rest position, for example, the position shown in FIG. 1C or FIG. 1D, etc.; however, for the ease of description, the depiction in FIG. 1B will be considered the rest position in this embodiment.

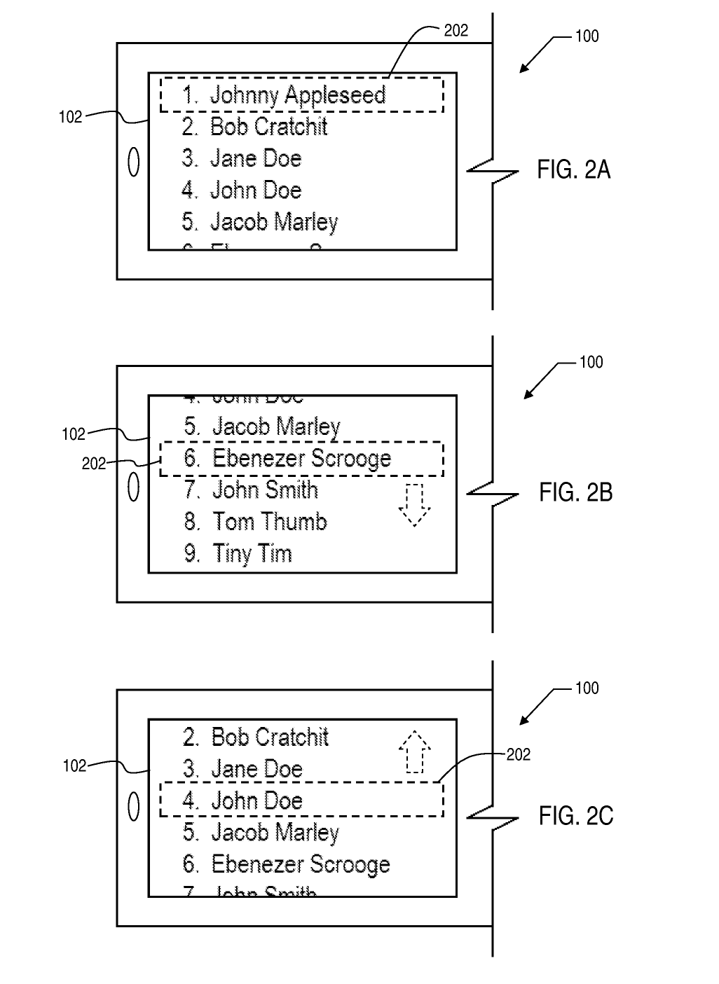

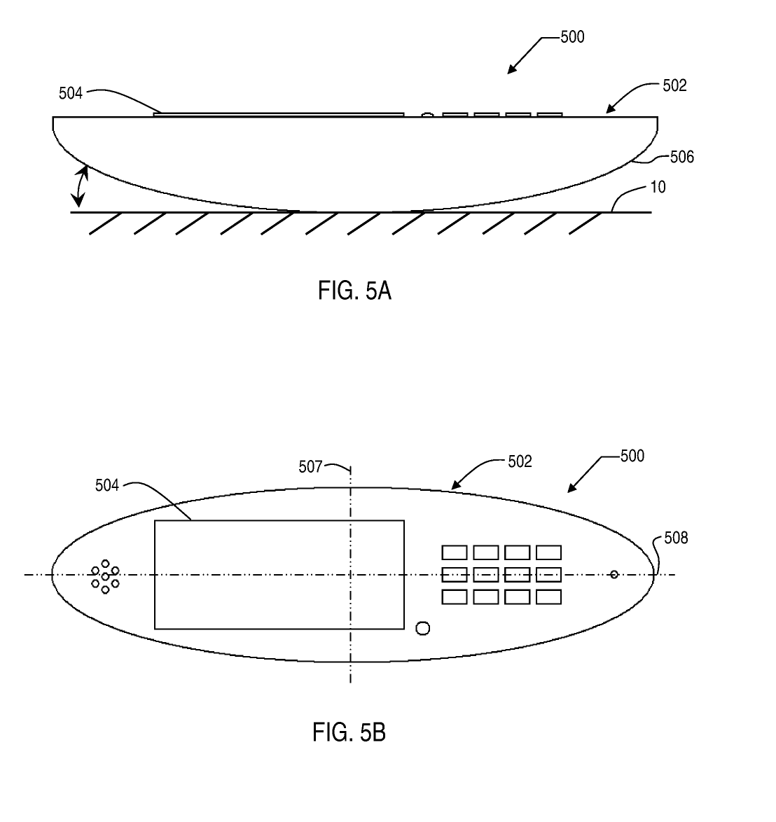

FIG. 2A is a partial top plan view of the device 100 of FIG. 1A showing the display 102 when the device 100 is in the rest position/orientation of FIG. 1B. As shown in FIG. 2A, a menu or list of contacts are displayed on the display 102, and a selection cursor in the form of a selection box 202 is shown at an initial position around the first contact name listed, namely “Johnny Appleseed.” Alternatively, the selection cursor could be in the form of a highlighting of a contact name, or repeated flashing of a contact name, or a contact name could be of a different color than the other contact names, or any other visual indicator can be used. Thus, if the user of the device 100 desires to retrieve the contact information for Johnny Appleseed, then the user could simply hit a selection button or other user input device to select the contact name indicated by the selection cursor (see also, the tilting selection discussed with respect to the embodiment in FIGS. 5A and 5B), which can cause the display 102 to move to a sub-menu or to display the contact information in this instance.

In order to utilize the movement-controlled display feature of the device 100, the user can roll the housing 110 forward or rearward. For example, the user can push or tap either a front portion of the top face of the housing 110 to cause the housing to roll forward as depicted in FIG. 1C by angle 12 (or a range of angles), or a rear portion of the top face of the housing 110 to cause the housing to roll rearward as depicted in FIG. 1D by angle 14 (or a range of angles). FIG. 2B is a partial top plan view of the device of FIG. 1A showing the display thereof when the device is in the second position/orientation of FIG. 1C (i.e., when the device is rolled forward by angle 12). When the device is rolled forward, the sensor 120 senses the movement and controller 300 controls the information displayed on the display 102 in response to the sensed movement. Thus, if the device is rolled forward, then the selection box 202 is moved down through the menu or contact list (as shown by the dashed arrow in FIG. 2B), and is shown as being moved down to contact number 6, namely “Ebenezer Scrooge.” For example, the selection box 202 can be moved one contact number per forward tap of the housing by the user, or the user can hold the housing in the orientation shown in FIG. 1C for a period of time and the selection box 202 can move one contact number per predetermined holding period of time (e.g., the selection box can move one contact number for each second or each 0.5 seconds that the housing is held in the orientation shown in FIG. 1C). Similarly, when the device is rolled rearward by angle 14, the sensor 120 senses the movement and controller 300 controls the information displayed on the display 102 in response to the sensed movement. Thus, if the device is rolled rearward to the orientation shown in FIG. 1D, then the selection box 202 is moved upward through the menu or contact list (as shown by the dashed arrow in FIG. 2C), and is shown as being moved up to contact number 4, namely “John Doe.”

Thus, the user can use the rolling motion to scroll through various menus or pictures/diagrams/images (referred to generically herein as “background depictions”) in an intuitive manner. The direction of movement of the selection cursor or background depiction on the display 102 as compared to the direction of the rolling motion of the housing 110 can be related to one another in a manner that is intuitive to users of the device. For example, forward rolling of the housing can be configured to cause downward movement of a selection box in a menu (or a focus point of a background depiction) on the display if such is found to be intuitive to users, or alternatively rearward rolling of the housing can be configured to cause downward movement of a selection box in a menu (or a focus point of a background depiction) on the display if such is found to be intuitive to users.

Thus, the movement from the rest position/orientation in FIG. 1B to another orientation, such as the orientations in FIG. 1C or 1D, will control displayed information on the device, thus acting as a user input to the device. Such a feature will allow a user to quickly and easily utilize various software applications on the device.

The various positions/orientations shown in FIGS. 1B-1D are merely exemplary. For example, in an alternative embodiment, the depiction in FIG. 1C could be the default or rest position/orientation, with forward and rearward rotations therefrom influencing the information displayed on the display. Also, controller 300 could be configured to provide varying scrolling speeds based upon the angle at which the housing is rolled (e.g., as compared to the rest orientation/position). For example, the controller could be configured to scroll through a menu at one item (e.g., contact name, etc.) per second when the housing is at an angle of five to ten degrees from the rest orientation/position, and at two items per second when the housing is at an angle of eleven to fifteen degrees from the rest orientation/position, and at four items per second when the housing is at an angle of sixteen to twenty degrees from the rest orientation/position, etc. Alternatively, the controller could be configured to vary the scrolling speed in a continuous manner based on the angle, rather than in the stepped manner previously mentioned. Further, the controller 300 could be configured to recognize various tapping inputs from the user. For example, the controller 300 could be configured to recognize a single tap as a command to move one contact name in a menu, repeated taps occurring at intervals of greater than one second as commands to move single steps, and repeated taps occurring at intervals of one second or less as commands to move multiple steps at a time (e.g., to jump to the next (or the previous) page in a multiple page listing of contact names).

FIG. 3 is a block diagram of device components used for implementing the embodiment of the device 100 illustrated in FIGS. 1A-1D and 2A-2C. The controller (e.g., processor) 300 is coupled to the display 102, the keyboard (e.g., keypad(s), touchscreen, or other user input device(s)) 104, and a memory 306 in any well-known telephone configuration, for example. The controller 300 is connected to a signal receiver/transmitter 302 that receives communication signals from and sends communication signals to other telephones or communication devices directly or via a wireless or wired communication network (e.g., cellular communication network, voice over internet protocol network, public switched telephone network, short or multimedia messaging system networks, radio transmission/receiver system, etc.). The controller 300 is connected to, and receives input from a user using the microphone 106 and provides output to the user using the speaker 108 via an audio interface 304.

The controller 300 is additionally coupled to the sensor 120 that is configured to sense the motion and orientation of the device 100. If an accelerometer and/or gyroscope are used as the sensor 120, then these devices can be used to sense movement of the device, and distinguish movements caused by external sources in order to determine external user input. If errors occur in the sensing of the user input, for example, due to unintended external input (e.g., if the device is moved by a force other than applied by the user), then the user can input corrective instructions using the keyboard or other user input device.

The controller 300 and memory 306 can be used to create and store various user preferences or settings that define the input movement parameters used by the device 100 to determine user input by rolling, and/or can simply store and perform such functions based on default settings. For example, the user can set the specific default or rest orientation/position of the device 100, or setting for the scrolling speed features discussed above, or the angle of roll needed to control the displayed information, or the direction of roll that results in a specification direction of scroll (e.g., forward roll results in downward scrolling, or rearward roll results in upward scrolling), etc. Thus, the user can have control over the various inputs recognized by the device as user inputs with respect to the movement-controlled display feature.

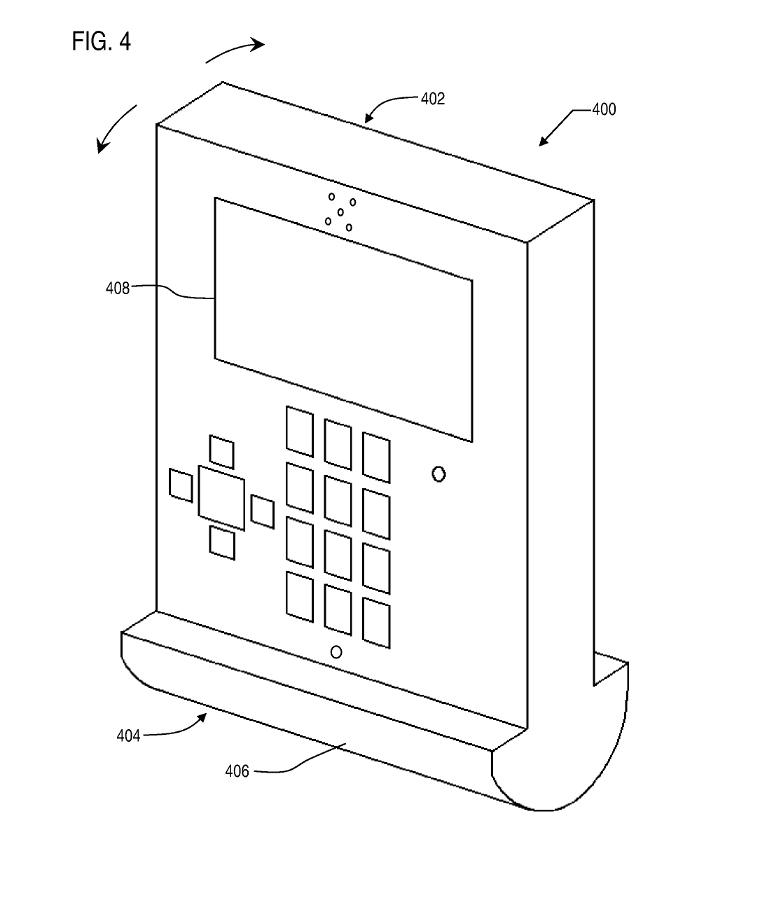

FIG. 4 depicts an additional embodiment of a device 400 that is configured to control displayed information thereon in response to movement thereof. The device 400 is in a configuration, for example, of a telephone or videophone that can be used as a desk or table phone. The device 400 includes an upper portion 402 that is generally vertically oriented in a rest position/orientation and includes a display 408, keyboard, microphone, and speaker. The upper portion 402 is attached to a base portion 404 that includes a curved support surface 406 that is similar to the curved support surface 112. The upper portion 402 and/or base portion 404 can be provided with a sensor, such as sensor 120, and controller, such as controller 300, such that rolling movement of the device 400 on the curved support surface 406 in a manner similar to that shown in FIGS. 1B-1D will influence information displayed on the display 408 in a manner similar to that shown in FIGS. 2A-2C. Thus, for example, the user can rock the device 400 backwards and/or forwards (as shown by the arrows) in order to utilize the movement-controlled display feature.

FIGS. 5A and 5B depict a further embodiment of a device 500 that is configured to control displayed information thereon in response to movement thereof. The device 500 is in a configuration of a telephone. The device 500 includes a housing 502 with an upper face that is generally horizontally oriented in a rest position/orientation and includes a display 504, keyboard, microphone, and speaker. The housing 502 includes a curved support surface 506 that has a generally semi-circular cross-section when taken along a vertical, transverse plane (e.g., extending through axis 507 in FIG. 5B) and generally semi-elliptical in cross-section when taken along a vertical, longitudinal plane (e.g., extending through axis 508 in FIG. 5B). The housing 502 houses a sensor, such as sensor 120, and controller, such as controller 300. As will be described in greater detail below, the curved support surface 506 of the device 500 allows the housing 502 to roll about axis 507, about axis 508, and any combination thereof in order to provide various directional input commands to control the displayed information on the display 504.

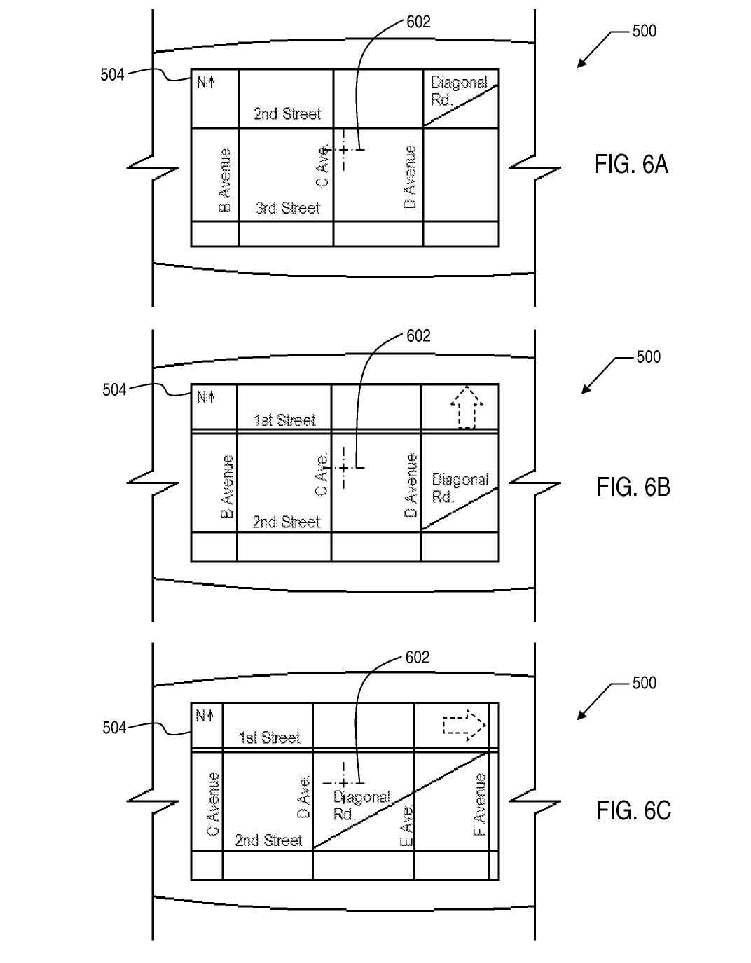

FIG. 6A is a partial top plan view of the device 500 of FIGS. 5A and 5B showing the display 504 when the device 500 is in the rest position/orientation of FIG. 5A. As shown in FIG. 6A, a map is displayed on the display 504, and a selection cursor in the form of a center marker 602 is shown at an initial position near the corner of “2^{nd} Street” and “C Ave.” The selection cursor can alternatively be in the form of a selection pointer, or alternatively no selection cursor can be provided.

In order to utilize the movement-controlled display feature of the device 500, the user can roll the housing 502 forward, rearward, left, right, or in any direction therebetween. For example, the user can push or tap a rear portion of the top face of the housing 502 to cause the housing to roll rearward about axis 508. FIG. 6B is a partial top plan view of the device 500 and the display 504 thereof when the device 500 rolled rearward about axis 508. When the device 500 is rolled rearward, the sensor therein senses the movement and the controller therein controls the information displayed on the display 504 in response to the sensed movement. Thus, when the device 500 is rolled rearward, then the center marker 602 is moved upward with respect to the map (or background depiction) as shown by the dashed arrow in FIG. 6B, and thus the center marker 602 is shown at a new position near the corner of “1^{st} Street” and “C Ave.” (Alternatively, the map can be moved upward with respect to the center marker 602 in response to the rearward rolling of the housing 502 if desired.)

FIG. 6C is a partial top plan view of the device 500 and the display 504 thereof when the device 500 rolled to the right about axis 507. When the device 500 is rolled to the right about axis 507, the sensor therein senses the movement and the controller therein controls the information displayed on the display 504 in response to the sensed movement. Thus, when the device 500 is rolled to the right about axis 507 (i.e., clockwise about axis 507), then the center marker 602 is moved to the right with respect to the map (or background depiction) as shown by the dashed arrow in FIG. 6C, and thus the center marker 602 is shown at a new position near the corner of “1^{st} Street” and “D Ave.” (Alternatively, the map can be moved to the right with respect to the center marker 602 in response to the rolling of the housing 502 to the right about axis 507 if desired.)

Thus, the user can use the rolling motion to scroll through various menus or background depictions in an intuitive manner. The scrolling can be not only in forward, rearward, left, and right directions, but also at any diagonal angle therebetween. The direction of movement of the selection cursor or background depiction on the display 504 as compared to the direction of the rolling motion of the housing 502 can be related to one another in a manner that is intuitive to users of the device. Note also, that the rolling motion about axis 507 of the embodiment in FIGS. 5A and 5B can be used as a way to select an item in a menu (e.g., contact name “Johnny Appleseed” in FIG. 2A) and/or move to a sub-menu using such a selection. For example, a clockwise rolling motion about axis 507 could be used to move to a sub-menu of the selected item (e.g., a selection or open feature), and a counterclockwise rolling motion about axis 507 could be used to move up to a parent menu of the current sub-menu (e.g., a back feature).

As is apparent from the above description, numerous different housing shapes and rolling movements are contemplated by the present disclosure to provide a wide variety of devices having movement-controlled display features.

It should be noted that the exemplary embodiments depicted and described herein set forth the preferred embodiments of the present disclosure, and are not meant to limit the scope of the claims hereto in any way. Numerous modifications and variations of the present disclosure are possible in light of the above teachings. It is therefore to be understood that, within the scope of the appended claims, the disclosed concepts may be practiced otherwise than as specifically described herein.

What is claimed is:

1. A device comprising:
a housing having a curved support surface;
a display on the housing;
a sensor configured to sense rolling movement of the housing; and
a controller coupled to the display and the sensor;
wherein the controller is responsive to detection of rolling movement sensed by the sensor to control information displayed.

2. The device according to claim 1, wherein the controller is configured to control the display to move a displayed background depiction on in response to the detection of rolling movement.

3. The device according to claim 2, wherein the detected rolling movement comprises movement of the housing about a plurality of axes.

4. The device according to claim 1, wherein the controller is configured to move a displayed selection cursor in response to the detected rolling movement.

5. The device according to claim 4, wherein the selection cursor is moved through a displayed menu list in accordance with detected rolling movement of the housing about a first axis.

6. The device according to claim 5, wherein said selection cursor is moved to a sub-menu list in accordance with detected rolling movement of the housing about a second axis substantially perpendicular to the first axis.

7. The device according to claim 1, wherein the detected rolling movement comprises movement of the housing about a plurality of axes.

8. The device according to claim 1, wherein the curved support surface is semi-circular and/or semi-elliptical in cross-section.

9. A device comprising:
a housing having a curved support surface;
a display provided on the housing, said display being configured to display information; and
means for influencing the information displayed on the display in response to rolling movement of the housing.

10. The device according to claim 9, wherein the means for influencing the information displayed moves a background depiction or a selection cursor displayed on the display in response to the rolling movement of the housing.

11. The device according to claim 10, wherein the means for influencing the information displayed moves the background depiction or the selection cursor displayed on the display in response to the rolling movement of the housing about a plurality of axes.

12. The device according to claim 9, wherein the curved support surface is semi-circular and/or semi-elliptical in cross-section.

13. A method of influencing information displayed on a display of a device, the method comprising:
sensing rolling movement of a housing of the device having a curved support surface; and
changing the information displayed on the display in response to the sensed rolling movement of the housing.

14. The method according to claim 13, wherein the step of changing comprises moving a background depiction displayed on the display in response to the rolling movement of the housing.

15. The method according to claim 14, wherein the step of sensing comprises detecting rolling movement of the housing about a plurality of axes.

16. The method according to claim 13, wherein the step of changing comprises moving a selection cursor displayed on the display in response to the sensed rolling movement of the housing.

17. The method according to claim 16, wherein the step of moving comprises resetting cursor selection of a displayed menu item in response to sensed rolling movement of the housing about a first axis.

18. The method according to claim 17, wherein the step of moving further comprises setting cursor of a displayed sub-menu item in response to sensed rolling movement of the housing about a second axis substantially perpendicular to the first axis.

19. The method according to claim 13, wherein the step of sensing comprises detecting rolling movement of the housing about a plurality of axes.

20. The method according to claim 13, wherein the curved support surface is semi-circular and/or semi-elliptical in cross-section.
